(19) United States
(12) Patent Application Publication
(10) Pub. No.: US 2008/0245396 A1
(43) Pub. Date: Oct. 9, 2008

(54) Inflatable splash washer and method

(75) Inventor: David J. Fitzgerald, Hayward, CA (US)

Correspondence Address: Law Offices of John W. Carpenter, 405 Davis Court, Suite 707, San Francisco, CA, 04111, US

(73) Assignee: WHAM-O Corporation, Emeryville, CA (US)

(21) Appl. No.: 11/784,634

(22) Filed: Apr. 9, 2007

(51) Int. Cl. B08B 3/00; A63H 3/06

(52) U.S. Cl. 134/123; 446/221; 134/198

(57) ABSTRACT

A method for discharging a fluid in an inflated assembly. The method includes inflating a roller assembly having a roller, rotatably coupling the inflated roller assembly to an inflated structure, and discharging a fluid against the inflated roller assembly to cause the inflated roller to rotate. An inflated water toy comprising an inflated structure, and an inflated roller assembly rotatably supported by the inflated structure, and a conduit assembly for discharging a fluid against an inflated roller of the inflated roller assembly and for conducting fluid to other locations on the inflated structure for dispersing the liquid from the other locations.

### FIELD OF THE INVENTION

Embodiments of the present invention are related to an inflatable toy assembly that emits or discharges water. More specifically, embodiments of the present invention provide an inflatable toy assembly that discharges a fluid to simulate a car wash, and a method for inflating a water-toy assembly and providing a conduit assembly for the inflated toy assembly for conducting and discharging an aqueous matter, such as water.

### BACKGROUND OF THE INVENTION

There are a number of water-dispersion devices available for children's recreational purposes, such as water slides, water-spraying devices, sprinkler hoops, etc. However, none combine the features of an inflatable “drive-through” structure that emulates the rotating and/or revolving and sequential water dispersion of a real car wash.

### SUMMARY OF EMBODIMENTS OF THE INVENTION

Embodiments of the present invention provide a method for dispersing a fluid, such as an aqueous fluid. In an embodiment of the invention, the method comprises inflating a roller assembly, rotatably coupling the inflated roller assembly to an inflated structure, and discharging a fluid against the inflated roller assembly to disperse the fluid.

Embodiments of the present invention also provide an inflated assembly comprising an inflated structure, and an inflated roller assembly rotatably supported by the inflated structure, and a conduit assembly for discharging a fluid against the inflated roller assembly and for conducting fluid to other locations on the inflated structure for dispersing the fluid.

These provisions, together with the various ancillary provisions and features which will become apparent to those skilled in the art as the following description proceeds, are attained by the methods and assemblies of the present invention.

### BRIEF DESCRIPTION OF THE DRAWINGS

FIG. 1 is a perspective view of an embodiment of the invention.

FIG. 2 is a rear elevational view of an embodiment of the invention.

FIG. 3 is a rear elevational view of another embodiment of the invention.

FIG. 4A is a side elevational view of an embodiment of the invention.

FIG. 4B is a partial side elevational view of a side of a generally U-shaped side member.

FIG. 5 is a side elevational view of another embodiment of the invention.

FIG. 6 is a front elevational view of an embodiment of the invention.

FIG. 7 is a front elevational view of another embodiment of the invention.

FIG. 8 is a top plan view of an embodiment of the invention.

FIG. 9 is a top plan view of another embodiment of the invention.

FIG. 10 is an enlarged side elevational of the inflated roller member illustrating a fluid being discharged against the fins of the inflated roller member to cause it to rotate.

### DETAILED DESCRIPTION OF THE EMBODIMENTS OF THE INVENTION

In the description herein, numerous specific details are provided, such as examples of components and/or methods, to provide a thorough understanding of the embodiments of the present invention. One skilled in the relevant art will recognize, however, that an embodiment of the invention may be practiced without one or more of the specific details, or with other apparatus, systems, assemblies, methods, components, materials, parts, and/or the like. In other instances, well-known structures, materials, or operations are not specifically shown or described in detail to avoid obscuring aspects of the embodiments of the present invention.

Referring in detail now to the drawings, wherein similar parts of the invention are identified by like reference numerals, there is seen in FIG. 1 a perspective view of an inflated structure assembly, generally illustrated as 10. The inflated structure 10 is preferably a toy. More particularly, the inflated structure 10 comprises a water-toy assembly that discharges water onto a human (e.g., child) passing through the water-toy assembly.

The inflated structure assembly 10 includes an inflated structure 12 which may be any suitable inflated structure for any suitable use, such as by way of example only, a drive-through wash for kids on bikes, tricycles and scooters, all generally illustrated as 14. When the inflated structure assembly 10 is deflated, it has the appearance of a wrinkly pile of neatly folded sheets of vinyl material. When the inflated structure assembly 10 is deflated, it may be stored, such as in a box.

The inflated structure 12 includes a generally U-shaped rear member 18 and a pair of generally U-shaped front members 22 and 23 which are coupled, preferably integrally coupled, to the rear member 18. The rear member 18 and the pair of front member 22 and 23 are all generally hollow and generally communicate with each other to allow all members to generally inflate simultaneously when communicating and/or being provided with a stream of pressurized air. More particularly, rear member 18 couples to and is in general communication with both front member 22 and 23, as best shown in FIG. 1.

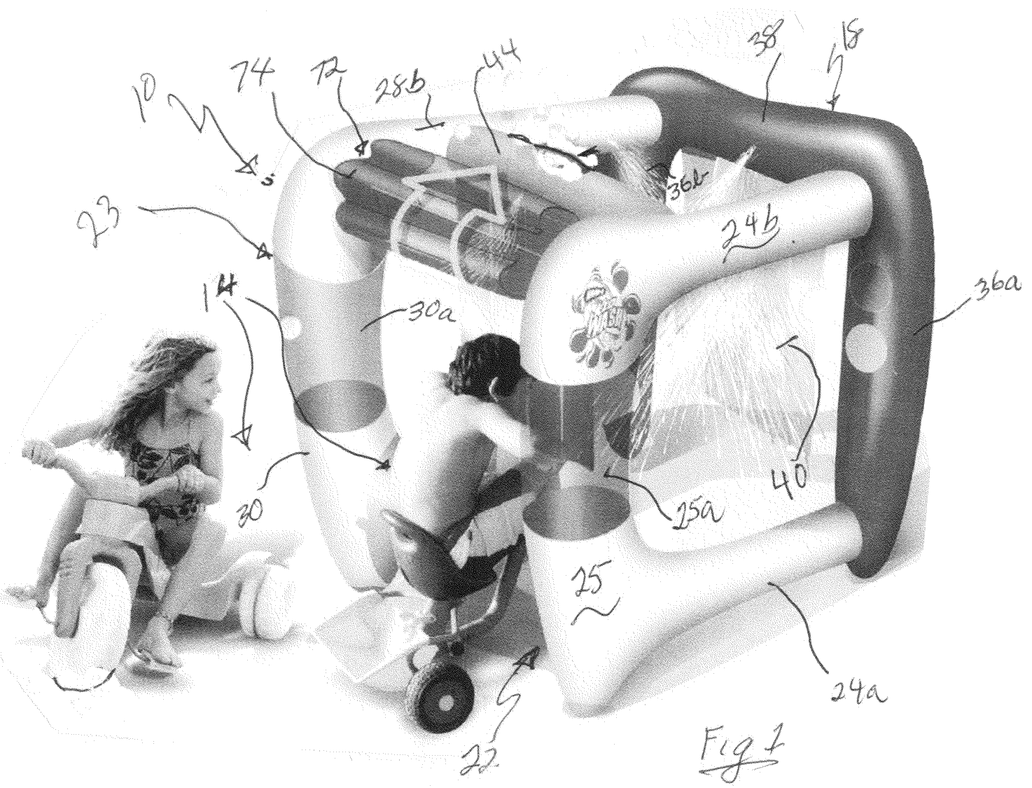

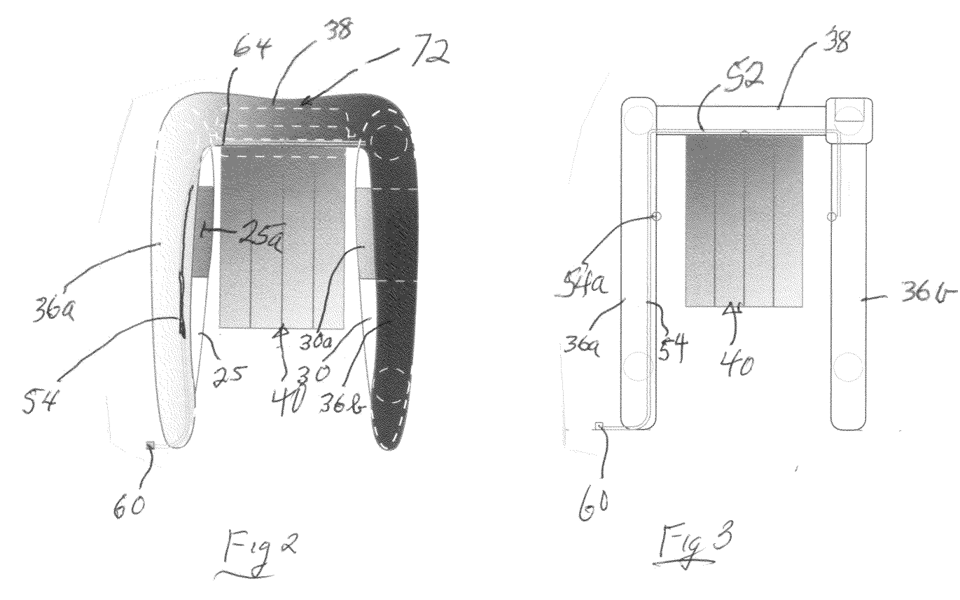

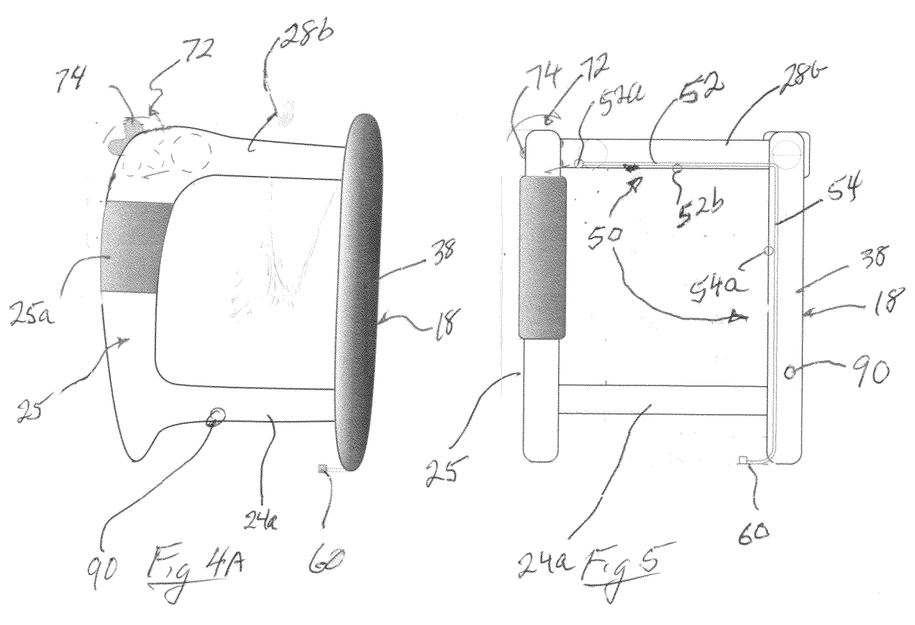

The inflated front member 22 has a pair of opposed inflated arms 24a-24b coupling, preferably integrally coupling, to a generally hollow cross member 25. In an embodiment of the invention, the cross member 25 may be provided with a transparent section 25a. The inflated front member 23 includes a pair of opposed inflated arms 28a and 28b (see FIG. 4A) coupling, preferably integrally coupling, to a generally hollow cross member 30. In an embodiment of the invention, the cross member 30 may be provided with a transparent section 30a.

The inflated rear member 18 has a pair of opposed inflated arms 36a-36b coupling, preferably integrally coupling, to a generally hollow cross member 38. Coupling to the cross member 38 in a dependent relationship is a plurality of wiper members 40 which emulate wipers of a typical car wash. As best shown in FIGS. 1 and 4A, the opposed inflated arms 36a and 36b of the rear member 18 communicate with and are integrally secured to arms 24b and 24a of front member 22 and to arms 28b and 28a of front member 23. An intermediary inflated cross member 44 interconnects, preferably integrally interconnects, arm 24b of member 22 with arm 28b of member 23.

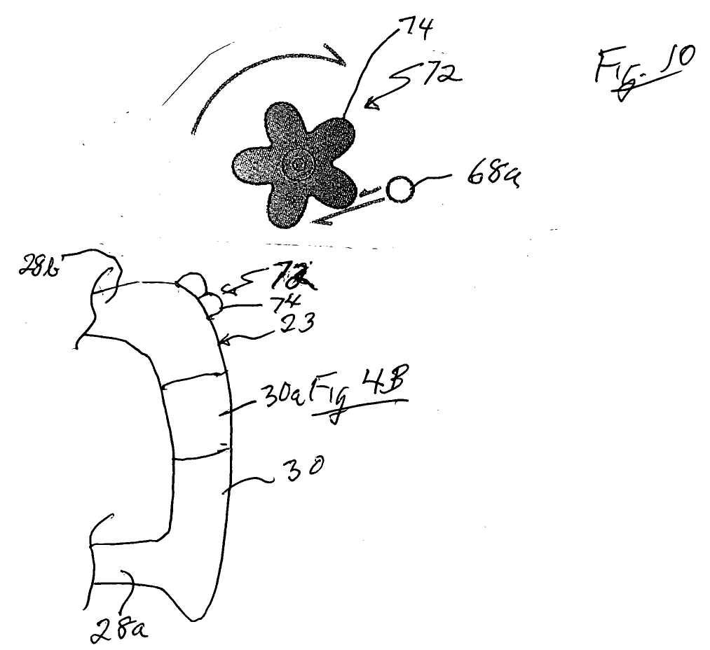

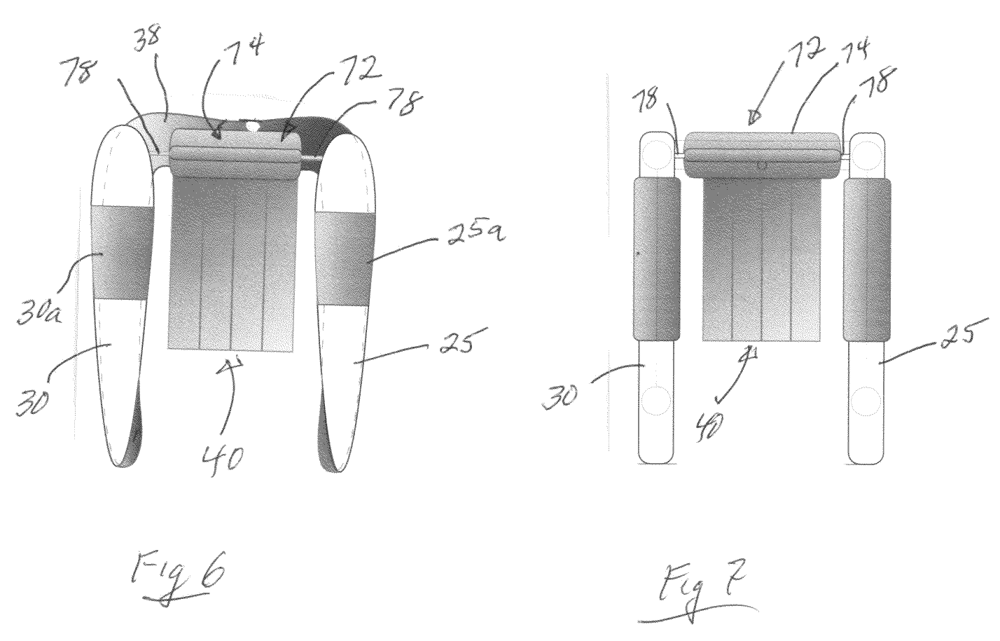

The inflated structure assembly 10 additionally includes a conduit assembly, generally illustrated as 50. The conduit assembly 50 may be conveniently displaced at any locations for selectively discharging and/or dispensing water. More particularly, the conduit assembly 50 has a conduits 52, 54, and 56 respectively including nozzle members 52a, 54b and 56a for discharging water toward the inside of the inflated structure 12, as best shown in FIGS. 1, 4A and 8. At least one of the nozzle members (e.g., nozzle 52a, see FIG. 5) would be in a position for discharging water against an inflatable roller assembly (identified below as “70”). The conduits may be partially included or totally included (except for the nozzles associated therewith) within (and/or along) the arms and cross member (e.g., arms 28b, 24b and 36a and cross member 38) of the inflated structure 12. Typically the conduit assembly 50 would be flexible enough to fold and/or collapse concomitantly with its associated structures when the inflated structure assembly 10 is collapsed into a deflated posture. Thus, when the inflated structure assembly 10 is deflated, the conduit assembly 10 collapses to be able to fold and/or bend with the deflated structure assembly. The conduit assembly 50 has an opening 60 for engaging a water supplying member, such as an ordinarily garden hose.

In a preferred embodiment of the invention, as best illustrated in FIGS. 1, 8 and 9, the conduit assembly 50 comprises conduit 62 communicating with and connected to conduit 64, and conduit 66 interconnecting conduit 64 with conduit 68. The latter conduit (i.e., 68) extends within and/or along cross member 44. Conduits 62, 64, 66 and 68 have nozzles 62a, 64a, 66a and 68a. Nozzle 68a discharges and/or emits water against an inflatable roller assembly, generally illustrated as 70. At least one of the conduits in the conduit assembly 50 of FIGS. 1, 8 and 9 interconnects with or is coupled to a water supplying member (e.g., a garden hose). The inflated roller assembly 70 is rotatably coupled to the inflated structure 12. Preferably, the inflated roller assembly 70, as best shown in FIGS. 1, 8 and 9, straddles the opening between generally U-shaped front members 22 and 23, more particularly between the opening defined by the space separating arm 24b of front member 23 and arm 28b of front member 22. As water is discharged and/or sprayed against the inflated roller assembly 70, the inflated roller assembly 70 rotates while changing the direction of the discharged or sprayed water such that water leaving the inflated roller assembly 70 simulates a water fall (i.e., a blanket of water flowing downward) for contacting a person entering the inflated structure assembly 10.

Referring in detail now to FIG. 10, there is seen a side elevational view of the inflated roller assembly 70. The inflated roller assembly 70 includes an inflated roller 72. The inflated roller 72 is seen as having a plurality of fin members 74. As previously indicated, the inflated roller assembly 70 is rotatably coupled to the inflated structure 12 and is supported rotatably by the same. More particularly, and as illustrated in 6-9, the inflated roller 72 is rotatably coupled to the inflated structure 12. Water discharged from nozzle 68a contacts the inflated roller 72, causing, as previously suggested, the same to rotate (e.g., in direction of the arrow in FIG. 1) to change the direction of the discharged or sprayed water such that water leaving the roller 72 simulates a water fall.

While the drawings illustrate an inflated roller 72 having radial protruding fin members 74 equidistantly-spaced arcs from one another, it is to be understood that the spirit and scope of the present invention includes any inflated roller member having any shape, configuration, or representation (e.g., a shark or alligator having exposed teeth, etc).

The rotatable coupling of the inflated roller 72 onto or to the inflated structure 12 may be by any suitable means. By way of example, after the structure forming part of the inflated structure 12 has been inflated, opposed openings (not shown) may be available and/or exposed in the inflated structure 12 for rotatably receiving pin members 78-78 that are opposedly bound to the inflated roller 72 after inflation. By way of further example, after the structure forming part of the inflated structure 12 has been inflated, inflated structure 12 may possess the pin members 78-78 in an opposed relationship for rotatably lodging, or rotatably receiving, in respective opposed recesses or openings (not shown) formed in the roller after inflation. Thus, the pin members 78-78 in combination with recesses or openings form at least a partial axle (e.g. a pair of opposed axles) about which the roller 72 rotates. The pin members 78-78 also provide axis pivot points and may be manufactured from any suitable material, such as extruded plastic tubing or a dowel. Likewise, the structure forming the inflated structure 12 may also be manufactured from any suitable material, such as plastic or the like.

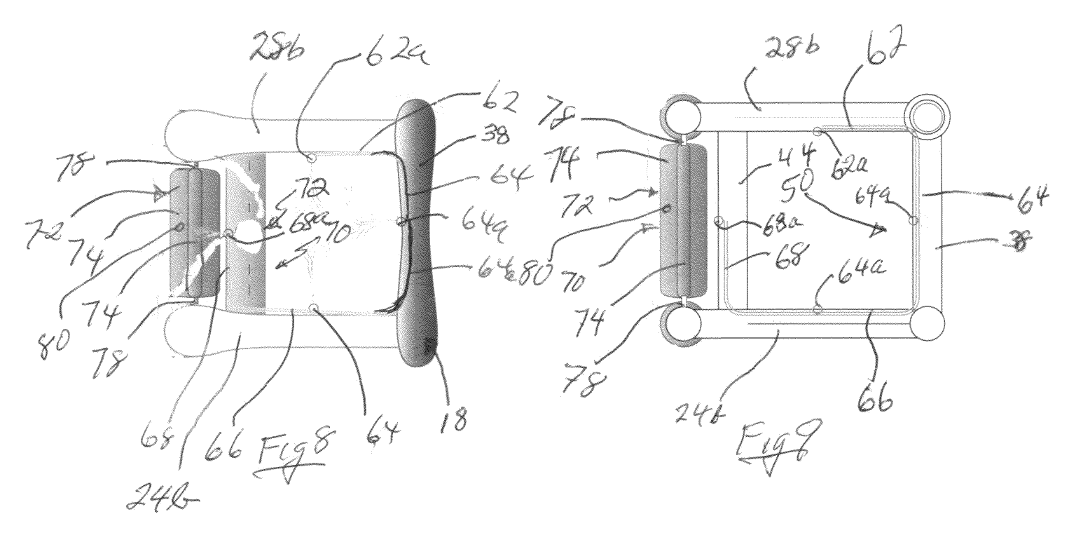

The roller 72 of the inflated roller assembly 70 is inflated separate and independent of the structure forming part of the inflated structure 12. The structure forming part of the inflated roller 72 includes an opening 80, which may be located at any suitable location, such as the location shown in FIGS. 8 and 9, and provides an outlet/inlet to which an air hose (not shown) may connect. The air hose connects to a blower/compressor for causing air to flow through the air hose and into the roller forming part of the inflated roller 72 to produce the inflated roller 72 (including inflated fin members 74) as a “fixed air” (i.e., a constant volume of air) roller (i.e., there is no continually blown air being received by the roller). After a suitable amount of air has passed through the air hose and produced the inflated roller 72, the air hose is removed from opening 80 which is then sealed off for maintaining air within the inflated roller 72. The “fixed air” inflated roller 72 emulates a balloon containing a fixed or constant volume of air. Obviously, the opening 80 would be a type of opening (e.g., a back pressure valve opening) that would prevent air from leaving the inflated roller 72.

The structure forming part of the inflated structure 12 includes an opening 90, which may be located at any suitable location, such as the location shown in FIGS. 8 and 9, and provides an outlet/inlet to which an air hose (not shown) may connect. The inflated structure 12 may be a “fixed air” device, as was seen for the inflated roller 74. After a suitable amount of air has passed through the air hose and produced the inflated structure 12, the air hose is removed from opening 90 which is then sealed off for maintaining air within the inflated structure 12. A typical fixed air structure may have multiple air chambers and fill valves. This makes the structure of the inflated structure 12 easier to inflate, and easier to repair if the inflated structure 12 starts leaking.

Fixed air structures for various embodiments of the present invention may have water tubing/conduits mounted inside or outside the hollow structures or chambers (see FIG. 8). This particular tubing configuration has multiple T-joints and nozzles, with one nozzle in particular spraying toward the impeller (i.e., the inflated roller 72). Another embodiment of the invention provides an inflated structure assembly 12 configured with multiple impeller components (i.e., multiple inflated rollers 72) conveniently positioned along arms 24b and 28b to produce multiple effects (i.e., effects produced by multiple inflated roller assemblies).

In another embodiment, as disclosed in U.S. Patent Application App. No. 433,925, filed May 15, 2006, incorporated herein by reference thereto, the air hose connects to a blower/compressor for causing air to flow through the air hose and through an opening (e.g., opening 90) into the structure forming part of the inflated structure 12 for inflating the structure into an upright posture to form the inflated structure 12. The blower/compressor continually blows air into the inflated structure 12 to compensate for air losses. An openable/closable opening, which may be positioned at any suitable location on the inflated structure 12, provides an opening for deflating the inflated structure 12. Alternatively and in a preferred embodiment of the invention, opening 90 may also provide a suitable opening for deflating the inflated structure 12. Thus, the inflated structure 12 of the splash washer may be a “fixed air” device, such as a balloon containing a fixed or constant volume of air. Alternatively, the inflated structure 12 may be an inflated structure 12 where the pressurized air is maintain by a constant air device, such as a blower/compressor.

Another embodiment of the invention provides an assembly comprising a collapsed or deflated structure, a collapsed or deflated roller assembly, and a collapsed conduit assembly. When the collapsed structure is inflated to form the inflated structure 12, the collapsed conduit assembly unwinds and de-collapses to form conduit assembly 50 for being associated with the inflated structure 12. The collapsed or deflated roller assembly is inflated to form the inflated roller assembly 72 which may then be rotatably disposed at a desired location on arms 28b and 24b (e.g., the location as shown in FIG. 1).

Practice of various embodiments of the present invention provides an inflatable drive-through (or peddle-through) wash with a water pressure-driven revolving overhead cam that creates a sheet of water through which children can ride their bicycles, tricycles, scooters, and other toy vehicles—in addition to top and side-mounted nozzle-like dispersion water jets that also simulate the experience of driving through a car wash. The rotating inflated roller 72 and its associated fins 74 enable a person to come in immediate contact with water that is leaving the inflated roller 72.

Reference throughout this specification to “one embodiment”, “an embodiment”, or “a specific embodiment” means that a particular feature, structure, or characteristic described in connection with the embodiment is included in at least one embodiment of the present invention and not necessarily in all its embodiments. Therefore, the respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Additionally, any arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of the illustrated embodiments of the present invention and are to be included within the spirit and scope of the present invention.

Therefore, while the present invention has been described herein with reference to the particular embodiments thereof, a latitude of modification, various changes and substitutions are intended in the foregoing disclosures, and it will be appreciated that in some instances some features of the embodiments of the invention will be employed without the corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for discharging a fluid in an inflated assembly comprising:
inflating a roller assembly having a roller;
inflating an inflatable structure having a conduit assembly including a plurality of nozzles;
rotatably coupling the inflated roller assembly including the inflated roller to the inflated structure; and
discharging a fluid against the inflated roller to cause the inflated roller to rotate.

2. The method of claim 1 wherein said inflated roller comprises at least one inflated fin member.

3. The method of claim 1 wherein said inflating the inflatable structure comprises inflating a pair of front generally U-shaped hollow members and inflating an intermediate hollow cross member which communicates with the generally U-shaped hollow members.

4. The method of claim 3 wherein the intermediate hollow cross member supports a conduit of the conduit assembly, and said discharging a fluid against the inflated roller comprises discharging the fluid from the conduit against the inflated roller to rotate the same.

5. The method of claim 4 wherein said conduit is disposed inside of the hollow cross member and includes a nozzle coupled to the conduit and exposed relative to a point on the structure of the inflated cross member for projecting fluid against the inflated roller.

6. The method of claim 3 wherein said inflating the inflatable structure additionally comprising inflating a rear generally U-shaped hollow member which is coupled to and communicates with the pair of front generally U-shaped hollow members.

7. The method of claim 6 wherein said rear generally U-shaped hollow member additionally comprises a plurality of wiper members depending therefrom.

8. The method of claim 6 wherein said conduit assembly discharges the liquid from at least one of the front generally U-shaped hollow members and from the rear generally U-shaped hollow member.

9. The method of claim 3 wherein a human passes through a space between the pair of front generally U-shaped hollow members and contacts the liquid leaving the inflated roller.

10. The method of claim 6 wherein a human passes through a space between the pair of front generally U-shaped hollow members and contacts the liquid leaving the inflated roller before contacting liquid being discharged from at least one of the front generally U-shaped hollow members and from the rear generally U-shaped hollow member.

11. An inflated water toy comprising an inflated structure, and an inflated roller assembly rotatably supported by the inflated structure, and a conduit assembly for discharging a fluid against an inflated roller of the inflated roller assembly and for conducting fluid to other locations on the inflated structure for dispersing the liquid.

12. The inflated water toy of claim 11 wherein said inflated roller comprises a plurality of fin members.

13. An inflatable water-toy assembly comprising a deflated structure, a deflated roller assembly including a deflated roller member having a plurality of deflated fin members, and a collapsed conduit assembly.
